(19) United States
(12) Patent Application Publication
(10) Pub. No.: US 2025/0245588 A1
(43) Pub. Date: Jul. 31, 2025

(54) Machine Learning Systems and Methods for Automatic Construction Scheduling and Expense Estimation

(71) Applicant: Xactware Solutions, Inc., Lehi, UT (US)

(72) Inventors: Jacob Jenson, Eagle Mountain, UT (US); Haowei Song, San Rafael, CA (US); Brian Brady, Troy, IL (US); John Britt, Byron Center, MI (US); Sihui Shao, Emeryville, CA (US); Cade Taylor, Highland, UT (US); Nicholas Sykes, American Fork, UT (US); Chuan-Sheng Wang, Quincy, MA (US)

(73) Assignee: Xactware Solutions, Inc., Lehi, UT (US)

(21) Appl. No.: 19/036,389

(22) Filed: Jan. 24, 2025

Related U.S. Application Data
(60) Provisional application No. 63/625,456, filed on Jan. 26, 2024.

(51) Int. Cl. G06Q 10/0631; G06Q 50/08

(52) U.S. Cl. CPC G06Q 10/06313; G06Q 50/08

(57) ABSTRACT

Machine learning systems and methods for automatic generation of construction schedules and expense estimates are provided. The system includes a data integration software layer which collects and pre-processes data generated from an insurance claims estimation software application; a machine learning (ML)/artificial intelligence (AI) software layer which extracts features from the data and trains and deploys one or more predictive machine learning models for generating construction schedules and expense estimates; and an automated construction schedule generation software layer which automatically generates a construction schedule and associated expense estimates using information generated by the data integration and ML/AI layers.

### BACKGROUND

### Related Applications

This application claims priority to U.S. Provisional Patent Application Ser. No. 63/625,456 filed on Jan. 26, 2024, the entire disclosure of which is hereby expressly incorporated by reference.

### Technical Field

The present disclosure relates generally to the field of machine learning. More specifically, the present disclosure relates to machine learning systems and methods for automatic construction scheduling and expense estimation.

### RELATED ART

In the field of insurance claims estimation and processing, the ability to rapidly and accurately generate construction schedules and associated expense estimates is of paramount concern. For example, insurers must have an accurate estimation of not only how long a particular construction project may take (e.g., a construction project to rebuild a damaged property subject to an insurance claim for such damage), but also the expenses associated with such construction projects. Such expenses are referred to in the insurance industry as “additional living expenses” and include costs associated with alternate housing for the insured (e.g., at a hotel or rental property) while a construction project is taking place, and other related expenses.

Often, inaccurate estimates of construction timelines and expenses are generated using existing techniques. Such inaccurate estimates can arise due to a number of causes, such as insurers often guessing at what would be the most efficient course of action in connection with alternate housing (e.g., whether to house the insured in long-term housing or a hotel) during a construction project, limited (or, no) accountability for construction scheduling (such that jobs are often overrun due to poor project management, or a lack of standards based on what is required to adequately complete a construction project), ineffective money management for a project (e.g., inadequate money saved in reserves for a project due to inadequate knowledge of a realistic project schedule, which can result in overestimation), a lack of construction expertise on behalf of the insurer, and other causes.

The fields of artificial intelligence and machine learning (AI/ML) are expanding at breathtaking rates, and AI/ML technology can greatly assist with solving the foregoing current shortcomings of construction and expense estimation practices. In particular, AI/ML technology holds the promise of addressing shortcomings in expertise deficiencies of insurers and a lack of knowledge and application of application standards, so as to create construction schedules and expense estimates using AI/ML models that can be trained on prior job experience data. Such models can also be trained to factor in information specific to particular contractors, as well as local market demands, seasonality, and the existence of other catastrophes and/or disasters, in order to automatically generate rapid and accurate construction schedules and expense estimates.

Accordingly, what would be desirable, but have not yet been provided, are machine learning systems and methods for automatic generation of construction schedules and expense estimates which solve the foregoing and other needs.

### SUMMARY

The present disclosure relates to machine learning systems and methods for automatic generation of construction schedules and expense estimates. The system includes a data integration software layer which collects and pre-processes data generated from an insurance claims estimation software application; a machine learning (ML)/artificial intelligence (AI) software layer which extracts features from the data and trains and deploys one or more predictive machine learning models for generating construction schedules and expense estimates; and an automated construction schedule generation software layer which automatically generates a construction schedule and associated expense estimates using information generated by the data integration and ML/AI layers.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is a diagram illustrating various software layers of the system of the present disclosure;

FIG. 3 is flowchart illustrating processing steps carried out by the software layers illustrated in FIG. 2; and

FIG. 4 is diagram illustrating various ML/AI models implemented by the system;

FIG. 5 is a sequence diagram illustrating operation the various ML/AI models of the system; and

FIGS. 6-10 are screenshots of user interface screens of a project management software tool operable with the systems and methods of the present disclosure.

### DETAILED DESCRIPTION

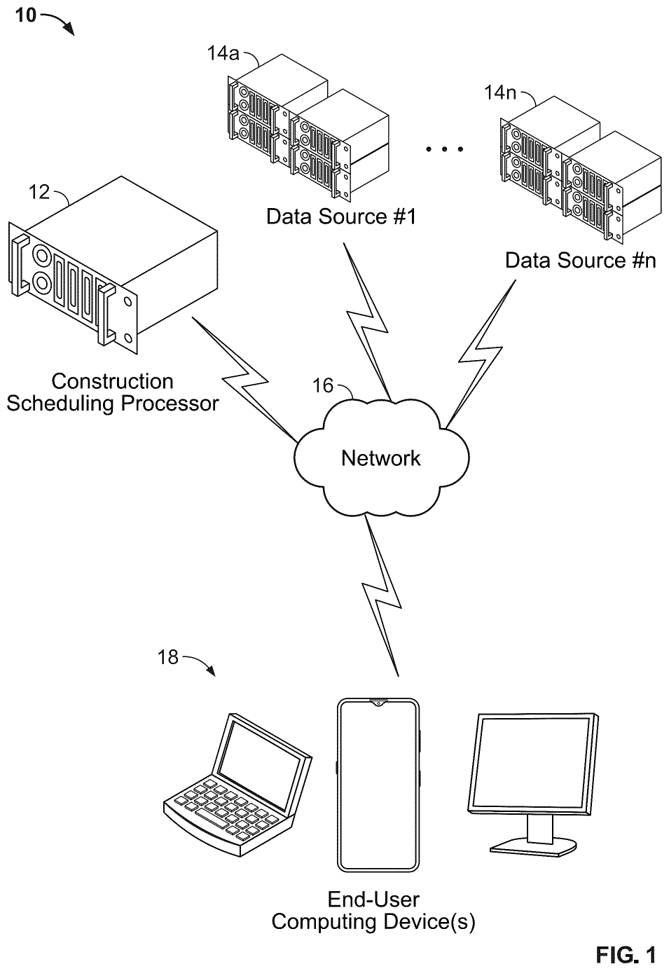

The present disclosure relates to machine learning systems and methods for automatic generation of construction schedules and expense estimates, as described in detail below in connection with FIGS. 1-10.

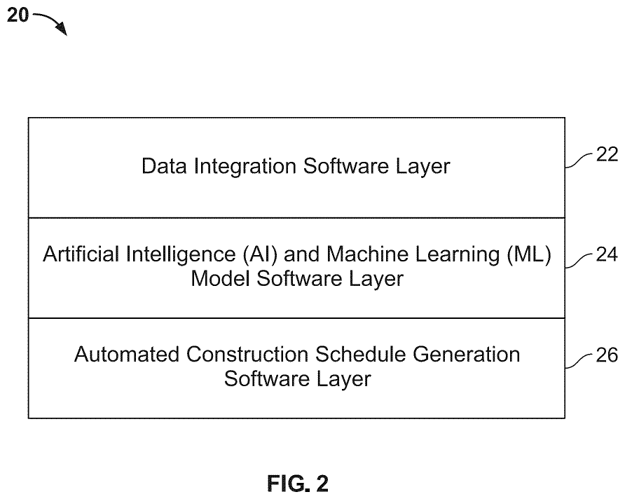

FIG. 1 is a diagram illustrating the system of the present disclosure, indicated generally at 10. The system 10 includes an automatic construction scheduling processor (computer system) 12 which is programmed to perform the various functions described herein. The processor 12 is in communication with one or more data source computer systems 14a-14n via a network 16, which could include a local area network (LAN), wide area network (WAN), an intranet, the Internet, a cellular data network, etc. The data source computer systems 14a-14n store information relating to insurance claims in connection with properties/structures that have been damaged and for which an insurance claim has been made and construction is required. As will be described in more detail in connection with FIG. 2, the processor 12 is programmed to include and executes a plurality of software layers that, together, provide the functionality and features described herein. The processor 12 automatically generates construction schedules and expense estimates as described herein using insurance claims data obtained from the data source computer systems 14a-14n. The construction schedules and expense estimates could be accessed and/or displayed on one or more end-user computing devices 18, which could include, but are not limited to, laptop computers, desktop computers, smart phones, tablet computing devices, or any other suitable devices. The processor 12 could be a server, a cloud computing platform, or other suitable computing device programming in accordance with the present disclosure using any suitable high- or low-level programming language, including, but not limited to, C, C++, Java, Javascript, Python, or other suitable language. Such programming could be embodied as non-transitory, computer-readable instructions stored in a memory associated with the processor 12 (e.g., read-only memory (ROM), disk memory, flash memory, random-access memory (RAM), etc.) and executed by the processor 12.

FIG. 2 is a diagram illustrating various software layers of the system of the present disclosure, indicated at 20. Such software layers 20 include a data integration software layer 22 which collects and pre-processes data generated from an insurance claims estimation software application; a machine learning (ML)/artificial intelligence (AI) software layer 24 which extracts features from the data and trains and deploys one or more predictive machine learning models for generating construction schedules and expense estimates; and an automated construction schedule software generation layer 26 which automatically generates a construction schedule and expense estimate for the structure using information generated by the data integration and ML/AI layers 22-24.

The data integration software layer 22 collects and pre-processes data generated from an insurance claims estimation software application. More specifically, the layer 22 receives a completed insurance claim adjustment assignment that could reside on an insurance carrier's computing system (e.g., one or more of the computer systems 14a-14n), as well as historical construction project and estimate data and data relating to applicable construction project rules/regulations/practices (e.g., from another of the computer systems 14a-14n), using a data collection process executed by the processor 12. Additionally, the software layer 22 normalizes and pre-processes the data so that it is suitable for analysis and further processing by the layers 24-26. Such normalization and pre-processing includes, but is not limited to, data cleaning, handling missing values in the data, and converting the data into one or more formats suitable for further processing by the system.

The machine learning (ML)/artificial intelligence (AI) software layer 24 extracts features from the data including details of damages, materials involved, labor costs, loss locations, and other information and trains and deploys one or more predictive machine learning models. More specifically, the layer 24 extracts relevant features from an insurance adjustment estimate and related data such as the details of damages, materials involved, lagor costs, losss locations, previous loss data, etc. Additionally, the layer 24 performs model training using historical data to train predictive models, as well as performing model deployment such that the trained models are deployed in order to make real-time predictions on new construction and expense estimates. The layer 24 could be coded using suitable machine learning frameworks and associated programming languages including, but not limited to, TensorFlow and Pytorch to build, train, and deploy predictive models, and Scikit-learn to develop machine learning algorithms, perform feature engineering, and for data preprocessing.

The automated building estimate software generation layer 26 automatically generates a construction schedule and expense estimate for the structure using information generated by the data integration and ML/AI software layers 22-24. Specifically, layer 26 analyzes estimate data (e.g., using outputs generated by the MI/AL layer 24) to determine (based on the trade at issue, e.g., plumbing, electrical work, etc.) actions that must be performed for a subject construction project, and the materials needed according to a pre-defined standard for completing the construction project. This can be performed by: taking the estimate and dividing out by trade based on historical data; taking each action and determining the time it would take based on the quantity and side of the action; standardizing the crew size (e.g., manpower) based on the size of the estimate and the trade; standardizing the lead times for each trade (e.g., the time it takes from one trade to another and the time it takes for materials to be ordered and delivered); and, as changes are made, the MI/AL layer 24 could be utilized to analyze the changes to determine what changes to the standard are required based on the region, trade, etc.

The layer 26 additionally generates and makes accessible to a wide variety of users (such as an insurance carrier, a contractor, a policy holder, and vendors, among others) an interactive construction schedule which indicates, in real time, the current status of a construction project and remaining milestones requiring completion. Still further, the layer 26 can generate alerts and notifications in the event that a project is modified and what tasks may still require completion.

The layer 26 is programmed to make specific calculations and decisions relating to both construction scheduling and expense estimation. For example, the layer 26 can calculate the amount of money required to temporarily house an insured in a hotel or long-term housing while a construction project is taking place, which assists an adjuster in determining which option would be most cost-effective. Additionally, the layer 26 can take inputs from other software applications and can verify expense estimates generated from such applications and calculate the expected total of expenses for a claim. An adjuster can also manually input expected expenses, for subsequent verification and processing by the layer 26.

It is additionally noted that the MI/Al layer 24 can track and process adjustments made to schedules and estimates, as well as historical data, in order to improve the system and further automate the generation of schedules and estimates. For example, if alterations are made to the size of a crew or project lead times, or if trades overlap or are divided, the layer 24 can evaluate such factors such as the specific trade involved, the tasks underway, the scale of the estimate, the cause for a loss, concurrent activities and trades, and the region where the job is being executed (among other factors), and can automatically adjust the standards applied by the system when future schedules and estimates are created.

Once the construction schedule and expense estimate is generated, the layer 26 transmits the schedule and expense estimate to an insurance carrier's claims processing software application (executing on one or more of the computer systems 14a-14n). Additionally, the layer 26 could execute a Robotic Process Automation (RPA) process to automate the process of creating and uploading the construction schedules and expense estimates, and/or one or more Application Programming Interfaces (APIs) or Software Development Kits (SDKs) could facilitate integration of the layer 26 with a carrier's claims processing software application or other third-party system.

It is noted that one or more of the layers 20 can additionally provide robust security measures to ensure data privacy and to comply with one or more relevant regulations such as GDPR, HIPAA, or other regulations. Additionally, the layers 20 could perform continuous monitoring and regular updates in order to ensure that the system is performing optimally, with proactive maintenance to adapt to changing requirements or data patterns.

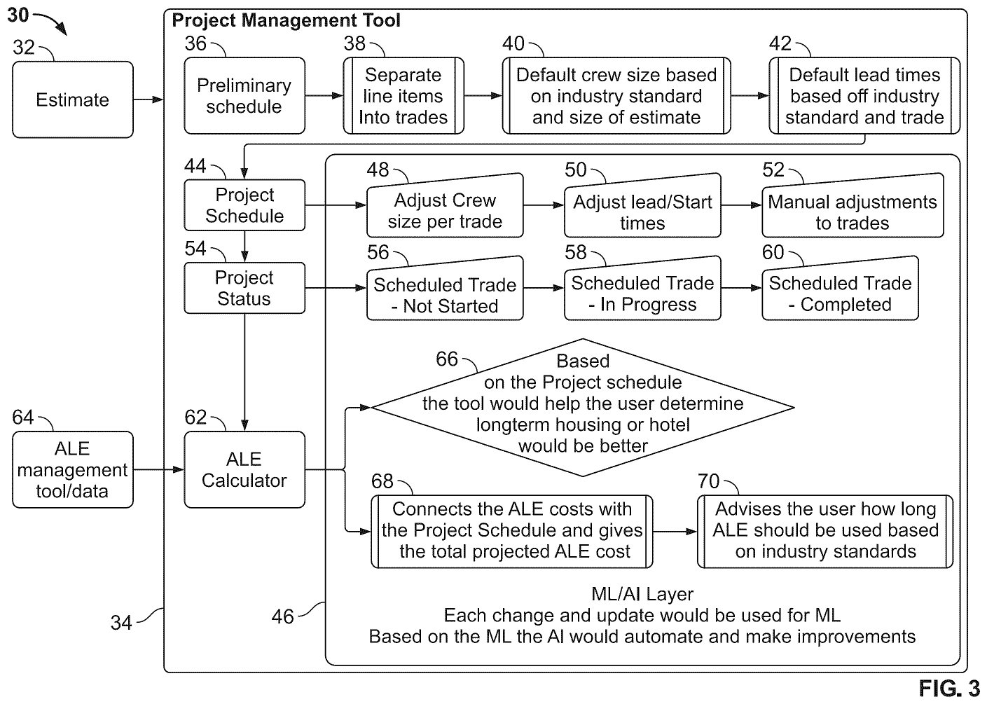

FIG. 3 is flowchart illustrating processing steps carried out by the system and indicated generally at 30. In step 32, an estimate is retrieved by the system via a project management tool 34 executed by the system. Next, in step 36, the system generate a preliminary schedule, and in step 38, the system separates line items of the preliminary schedule into trades. The preliminary schedule intelligently separates the estimate by each industry trade (e.g., carpenter, cabinets, flooring, drywall, etc.). Then, in step 40, the system determines a default crew size based on one or more industry standards as well as the size of the estimate. Next, in step 42, the system determines default lead times based on industry standards and the applicable trade for the estimate. Additionally, the system calculates the amount of time each trade will require based on the estimate, and intelligently adds the crew size for each trade to quantify the number of hours/days that trade will require for completion. Still further, the system can automatically include the lead times in the schedule based on industry standards and the applicable trade. In step 44, the system creates a project schedule based on the information determined in steps 38-42. The schedule can be manually adjusted by the user, allowing for a more accurate schedule based on the situational concerns of the project and when the project was actually completed.

In step 48, an MI/AL layer 46 (which could be the MI/AL layer 24 of FIG. 2) processes the project schedule and adjust the crew size per trade, based on prior training of the MI/AL layer 46. Next, in step 50, the layer 46 adjusts the lead and start times, and in step 52, the layer 46 optionally allows for manual adjustments to the trades. In step 54, the system determines the current status of the project. Using this information, in step 56, the layer 46 determines whether the scheduled trade has started performing work. Alternatively, in step 58, the system can determine whether the scheduled trade is in progress, or in step 60, whether the scheduled trade is complete.

In step 62, the system calculates expense estimates (e.g., additional living expenses (“ALE”)) for the project, using an ALE management tool 64 and associated data. Then, in step 66 the ML/AI layer 46 can process ALE data (including historical claims data, or other data tools/sources (including manual data entry)), and compares this data with the project schedule to assist the user to determine whether long-term housing or a hotel would be a more cost-effective option for the insured. Additionally, in step 68, the layer 46 connects the ALE costs with the projects schedule generated in step 44, and generates the total projected ALE cost for the project. Additionally, in step 70, the layer 46 advises the user as to how long the ALE should be used based on industry standards.

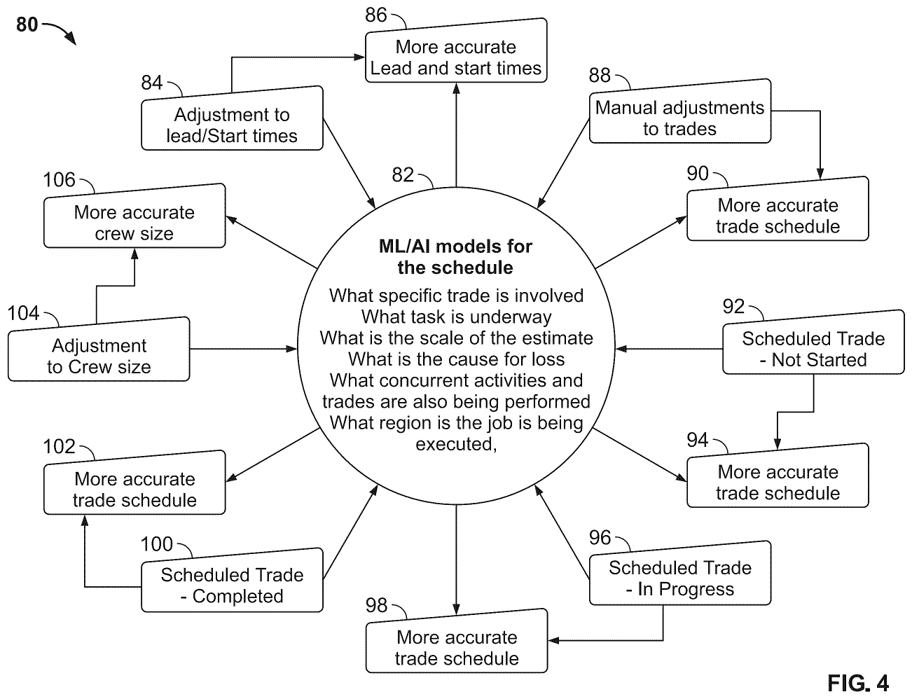

FIG. 4 is diagram, indicated generally at 80, illustrating various ML/AI models implemented by the system. The models 82 can process various inputs and outputs including, but not limited to, adjustments 84 to the lead/start times, more accurate lead and start times 86, manual adjustments 88 to trades, more accurate trade schedules 90, scheduled trade status information 92 (indicating that a trade has not yet started), more accurate trade schedule 94, scheduled trade status information 96 (indicating that a trade is in process), more accurate trade schedule 98, scheduled trade status information 100 (indicating that a trade is complete), more accurate trade schedule 102, adjustments 104 to crew sizes, and more accurate crew size 106. The models 82 can address one or more of the following questions using information learned by the models 82 over time: what specific trade is involved in a project, what task is currently underway in a given project, what is the scale of the estimate involved, what is the cause of the loss, what concurrent activities and trades are also being performed, and in what region a job is being executed.

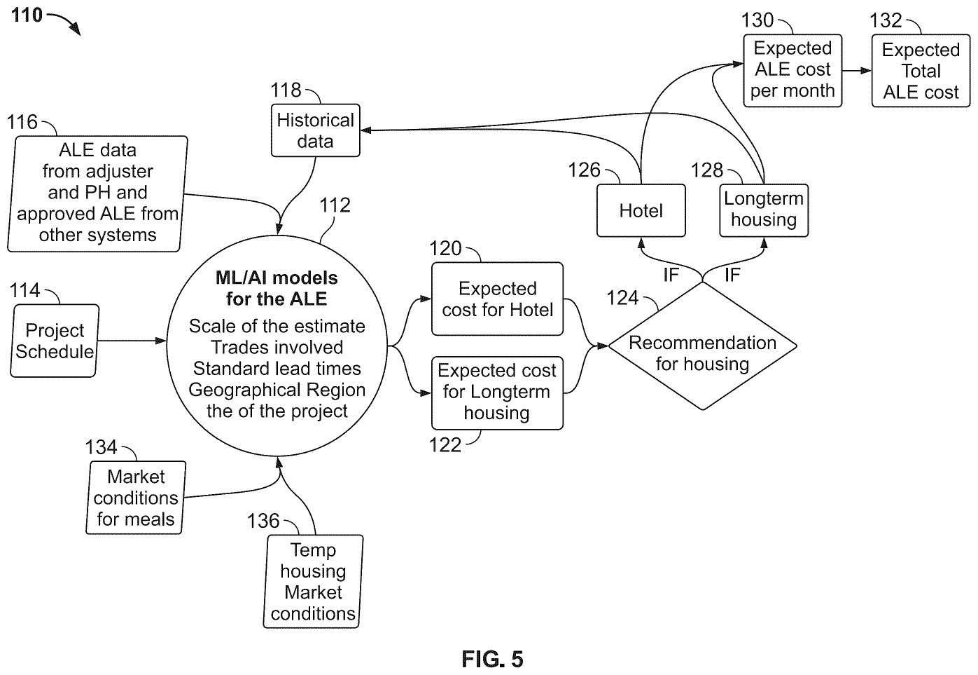

FIG. 5 is a sequence diagram illustrating operation the various ML/AI models of the system, indicated generally at 110. The models 112 (which correspond to any or all of the models described above) process a plurality of inputs including, but not limited to, a project schedule 114, ALE data 116 from an adjuster and/or other systems or information, historical data 118, market conditions 134 for meals, and data 136 relating to temporary housing market conditions. The models 112 can determine the scale of the estimate, the trades involved, standard lead times, and geographical regions of the project, among other information. The models 112 can generate outputs including the expected cost 120 for a hotel and the expected cost 122 for long-term housing.

The costs 120 and 122 can be further processed by the system in step 124 to determine and generate a recommendation for housing which can include a hotel housing recommendation 126 and a long-term housing recommendation 128. Both recommendations 126-128 can be added to the historical data 114 for future usage by, and/or training of, the models 112. Additionally, the recommendations 126-128 are processed in step 130 to calculate the expected ALE cost per month for the project. Finally, in step 132, the system calculates and outputs an expected total ALE cost for the project.

Advantageously, the system of the present disclosure employs AI, ML, and computer vision components in a software architecture that allows for automated creation of construction schedules and expense estimates. As a result, the system creates such schedules and estimates with improved speed and accuracy. Additionally, the system of highly scalable, in that each of the layers 20 can adapt to varying data volumes or business needs.

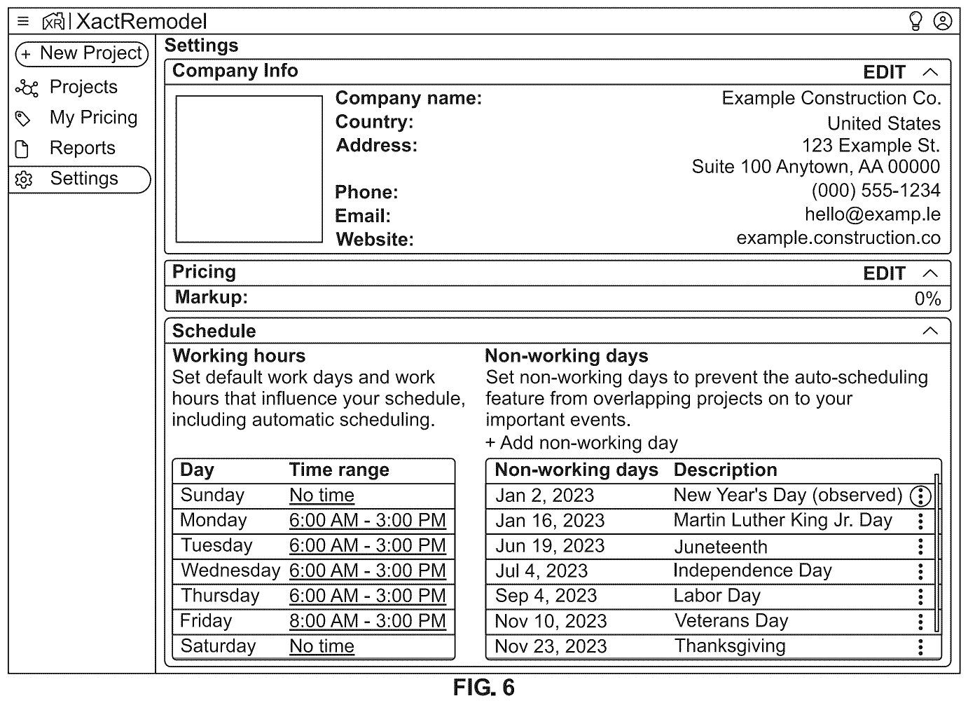

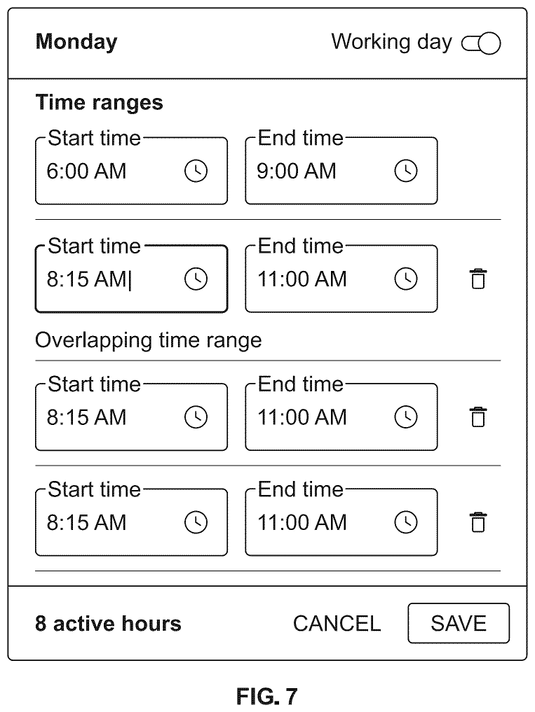

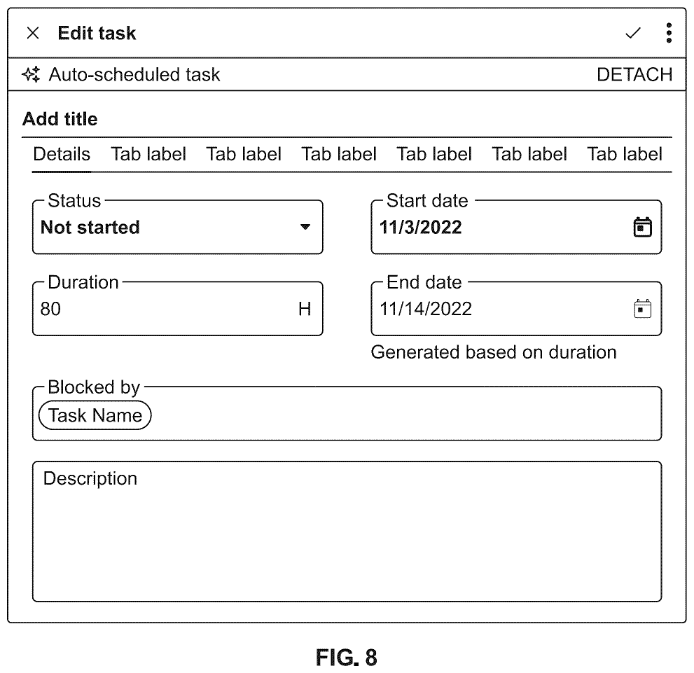

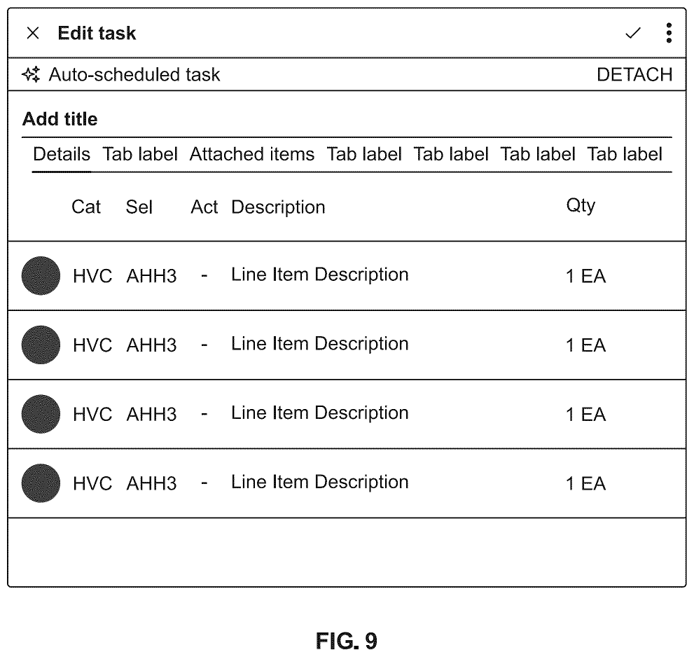

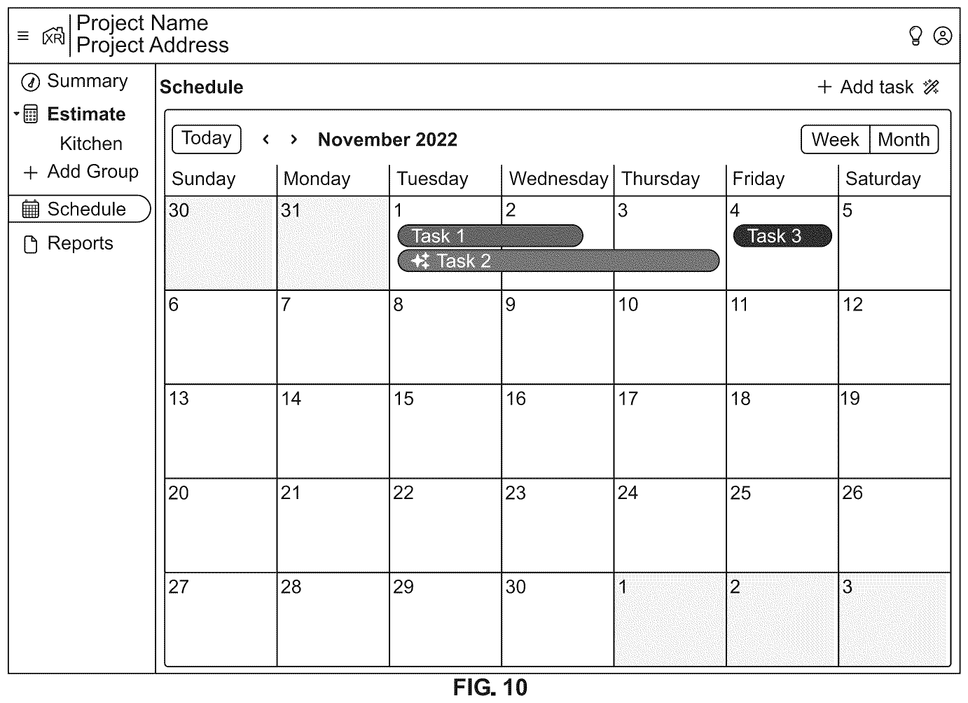

FIGS. 6-10 are screenshots of user interface screens of a project management software tool operable with the systems and methods of the present disclosure. The systems and methods of the present disclosure are interoperable with a wide variety of project management software tools, such that schedules can automatically be generated by the systems/methods herein and integrated into such software tools. For example, FIGS. 6-10 are screenshots of a project management software tool that includes various user interface controls for allowing users of the system to define, edit, and manage one or more project management schedules. Such controls could automatically be populated with project scheduling information and settings by the systems/methods of the present disclosure, including, but not limited to, working and non-working hours/days (FIG. 6), time ranges (FIG. 7), task names/descriptions (FIG. 8), line item descriptions (FIG. 9), and graphical calendar entries (FIG. 10).

It is additionally noted that the systems and methods of the present disclosure could allow for automatic schedule generation and management of items such as material lead times (e.g., through a direct supplier product/program, such that the system can determine the timeframe for ordering and receiving materials directly from suppliers, given factors in the market, to determine the timeframe for delivering materials directly to a jobsite); permit data (such that the system can determine the timeframe needed to submit a permit for a construction project, and the time estimates to receive permits and to proceed with a job); and/or material stock, equipment, and consumables tracking.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A machine learning system for automatic generation of construction schedules and expense estimates, comprising:
a processor;
a data integration software layer executed by the processor, the data integration software layer collecting and pre-processing data from an insurance claims estimation software application in communication with data integration software layer;
a machine learning software layer executed by the processor, the machine learning software layer extracting a plurality of features from the data and training and deploying at least one predictive machine learning model for generating construction schedule and expense estimates associated with the construction schedules; and
a construction schedule generation software layer executed by the processor, the construction schedule software generation layer generating a construction schedule and expense estimates associated with the constructions schedule using data generated by the machine learning software layer.

2. The machine learning system of claim 1, wherein the data integration software layer receives a completed insurance claim adjustment assignment from an insurance carrier computer system in communication with the processor.

3. The machine learning system of claim 2, wherein the data integration software layer receives historical construction project and estimate data.

4. The machine learning system of claim 3, wherein the data integration software layer receives data relating to at least one construction project rule, regulation, or practice.

5. The machine learning system of claim 1, wherein the data integration software layer normalizes the data.

6. The machine learning system of claim 1, wherein the machine learning software layer extracts the plurality of features from an insurance adjustment estimate.

7. The machine learning system of claim 6, wherein the plurality of features include one or more of damages, materials involved, labor costs or loss locations.

8. The machine learning system of claim 1, wherein the construction schedule generation software layer determines at least one action to be performed for a construction project.

9. The machine learning system of claim 8, wherein the construction schedule generation software layer determines materials needed according to a pre-defined standard for completing the construction project.

10. The machine learning system of claim 9, wherein the construction schedule generation software layer generates an interactive construction schedule indicating a real-time status of a construction project and remaining milestones.

11. The machine learning system of claim 1, wherein the construction schedule generation software layer transmits the construction schedule and the expense estimates to an insurance carrier claims processing software application.

12. The machine learning system of claim 1, wherein the machine learning software layer tracks and processes adjustments made to the construction schedule or the expense estimates.

13. The machine learning system of claim 1, wherein the machine learning software layer processes living expense data and compares the living expense data with the construction schedule to determine whether at least one of long-term housing or a hotel would be most cost-effective for an insured.

14. The machine learning system of claim 13, wherein the living expense data is included in the expense estimates.

15. A machine learning method for automatic generation of construction schedules and expense estimates, comprising:
executing a data integration software layer by a processor, the data integration software layer collecting and pre-processing data from an insurance claims estimation software application in communication with data integration software layer;
executing a machine learning software layer by the processor, the machine learning software layer extracting a plurality of features from the data and training and deploying at least one predictive machine learning model for generating construction schedule and expense estimates associated with the construction schedules; and
executing a construction schedule generation software layer by the processor, the construction schedule software generation layer generating a construction schedule and expense estimates associated with the constructions schedule using data generated by the machine learning software layer.

16. The machine learning method of claim 15, wherein the data integration software layer receives a completed insurance claim adjustment assignment from an insurance carrier computer system in communication with the processor.

17. The machine learning method of claim 16, wherein the data integration software layer receives historical construction project and estimate data.

18. The machine learning method of claim 17, wherein the data integration software layer receives data relating to at least one construction project rule, regulation, or practice.

19. The machine learning method of claim 15, wherein the data integration software layer normalizes the data.

20. The machine learning method of claim 15, wherein the machine learning software layer extracts the plurality of features from an insurance adjustment estimate.

21. The machine learning method of claim 20, wherein the plurality of features include one or more of damages, materials involved, labor costs or loss locations.

22. The machine learning method of claim 15, wherein the construction schedule generation software layer determines at least one action to be performed for a construction project.

23. The machine learning method of claim 22, wherein the construction schedule generation software layer determines materials needed according to a pre-defined standard for completing the construction project.

24. The machine learning method of claim 23, wherein the construction schedule generation software layer generates an interactive construction schedule indicating a real-time status of a construction project and remaining milestones.

25. The machine learning method of claim 15, wherein the construction schedule generation software layer transmits the construction schedule and the expense estimates to an insurance carrier claims processing software application.

26. The machine learning method of claim 15, wherein the machine learning software layer tracks and processes adjustments made to the construction schedule or the expense estimates.

27. The machine learning method of claim 15, wherein the machine learning software layer processes living expense data and compares the living expense data with the construction schedule to determine whether at least one of long-term housing or a hotel would be most cost-effective for an insured.

28. The machine learning method of claim 27, wherein the living expense data is included in the expense estimates.
